(19) United States
(12) Patent Application Publication
(10) Pub. No.: US 2023/0368262 A1
(43) Pub. Date: Nov. 16, 2023

(54) MANAGING CUSTOMER EXPERIENCE CONTENT

(71) Applicant: Oracle International Corporation, Redwood Shores, CA (US)

(72) Inventor: Vivek Kumar, Redwood City, CA (US)

(73) Assignee: Oracle International Corporation, Redwood Shores, CA (US)

(21) Appl. No.: 17/743,091

(22) Filed: May 12, 2022

(51) Int. Cl. G06Q 30/06; G06Q 30/02

(52) U.S. Cl. CPC G06Q 30/0629; G06Q 30/0201

(57) ABSTRACT

Techniques for managing customer experience content are disclosed. A system detects new information, such as a news story, a new service request, or a modification to a testimonial or case study, associated with a set of customer experience content, such as a customer testimonial. The system analyzes the new information to identify a sentiment associated with the new information. The system generates an effectiveness score for a particular set of customer experience content based on the new information. The system provides attribute data associated with the new information, and attribute data associated with the customer experience content, to a machine learning model to generate the effectiveness score. The system compares the effectiveness score to one or more threshold values to determine an action to perform associated with the customer experience content.

### TECHNICAL FIELD

The present disclosure relates to managing customer experience content. In particular, the present disclosure relates to determining an effectiveness of content associated with a customer experience with a product or service over time.

### BACKGROUND

When procuring new clients or pitching goods or services to existing clients, client procurement organizations improve their chances of success by demonstrating that past customers similar to the prospective customer have purchased similar goods or services and observed positive results. Client procurement organizations maintain customer testimonials that may be provided to prospective customers to show that a previous customer was pleased with a good or service.

For an organization with a large number of clients, it may be challenging for a salesperson to know which testimonial to provide to a prospective client. For example, a prospective client may find a testimonial by a much smaller, or much larger, customer unpersuasive. In addition, one prospective client may be less likely to purchase a good or service that was purchased by a direct competitor. Another prospective client may be more likely to purchase a good or service that was purchased by a direct competitor. It may be challenging for a salesperson to determine which situation applies to their prospective client.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A-1C illustrate a system in accordance with one or more embodiments;

FIG. 2 illustrates an example set of operations for managing customer experience content in accordance with one or more embodiments;

FIG. 3 illustrates a set of operations for training a machine learning model to generate an effectiveness score for customer experience content, according to one or more amendments;

FIG. 4 illustrates a set of operations for training a machine learning model to recommend customer experience content according to one or more embodiment

FIG. 5 illustrates an example embodiment of a system for managing customer experience content; and

FIG. 6 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. MANAGING CUSTOMER EXPERIENCE CONTENT
4. TRAINING MACHINE LEARNING MODEL TO GENERATE AN EFFECTIVENESS SCORE FOR CUSTOMER EXPERIENCE CONTENT
5. TRAINING MACHINE LEARNING MODEL TO RECOMMEND CUSTOMER EXPERIENCE CONTENT FOR TARGET CUSTOMER
6. EXAMPLE EMBODIMENT
7. COMPUTER NETWORKS AND CLOUD NETWORKS
8. MISCELLANEOUS; EXTENSIONS
9. HARDWARE OVERVIEW

### 1. General Overview

Companies rely on positive experiences of previous or existing customers to market goods or services to potential customers. Information about the positive experiences of past, or existing, customers is recorded as customer experience content. The customer experience content may be recorded in narrative form, such as in a testimonial or case study, which may provide a short account of the customer's experience with the product.

One or more embodiments manage customer experience content based on new information accumulated over time associated with a customer or a product. For example, a system may detect a news story describing a customer is filing for bankruptcy. A set of customer experience content associated with the customer may be less effective as a marketing tool if the customer is involved in a bankruptcy proceeding. As another example, subsequent to creating a testimonial describing a positive experience with a rollout of a software platform, a customer may generate tens of service requests indicating displeasure with the software platform. The testimonial describing the positive experience with the software platform may be less effective as a marketing tool when the customer later had problems with the software platform. As another example, a marketing employee may update a case study associated with a customer's purchase of human resources software to indicate the customer had grown over the past three years, and the software allowed the customer to grow efficiently. The case study describing the purchase and continued use of the human resources software may be more effective as a marketing tool if the human resources software is generating positive results for the customer.

One or more embodiments manage customer experience content in a repository or database by determining whether to purge, monitor, temporarily make unavailable, or maintain the customer experience content based on new information obtained over time. A system detects new information, such as a news story, a new service request, or a modification to a testimonial or case study. The system analyzes the new information to identify a sentiment associated with the new information. For example, a service request associated with a complaint corresponds to a negative sentiment. Conversely, a service request associated with a request for an upgrade may correspond to a positive sentiment. The system generates an effectiveness score for a particular set of customer experience content based on the new information. According to one embodiment, the system provides attribute data associated with the new information, and attribute data associated with the customer experience content, to a machine learning model to generate the effectiveness score. The system compares the effectiveness score to one or more threshold values to determine an action to perform associated with the customer experience content. If the effectiveness score is below a low threshold score, the system purges the content from a database of sets of customer experience content. The content is no longer available to be used as marketing content for potential customers. If the effectiveness score is between a low threshold and a high threshold, the system performs an intermediate action. For example, the system may flag the customer experience content for user review. In addition, or in the alternative, the system may temporarily prevent the use of the content for marketing purposes. For example, the system may indicate the content may not be used for marketing purposes for three months, at which time the effectiveness score should be re-calculated. If the effectiveness score is above a high threshold, the system may keep the customer experience content in the database and available for marketing purposes.

One or more embodiments generate an effectiveness score associated with a particular target customer (e.g., a “target customer effectiveness score”). The system provides (a) attribute data associated with new information, (b) attribute data associated with a particular set of customer experience content, and (c) attribute data associated with a target customer, to a machine learning model to generate a target customer effectiveness score. The target customer effectiveness score represents an effectiveness of providing a particular set of customer experience content to a particular target customer. The system compares the target customer effectiveness score to one or more threshold values to determine an action to perform associated with the customer experience content. If the effectiveness score is below a low threshold score, the system prevents the customer experience content from being used as marketing content for the target customer. However, the customer experience content may still be used as marketing content for other customers.

One or more embodiments trigger a re-generation of an effectiveness score for a set of customer experience content based on newly-obtained information about the customer experience content. For example, the system may detect a new service request associated with a particular testimonial describing a successful rollout of a software platform. The system may determine that the number of service requests associated with the particular testimonial exceeds a threshold number within a 30-day time period. The system may trigger a re-generation of the effectiveness score associated with the particular testimonial based on the determination that the number of service requests associated with the particular testimonial exceeds a threshold number within a 30-day time period. As another example, the system may detect a news story describing a customer expanding into a new market. The system may trigger a re-generation of the effectiveness score associated with a testimonial describing the customer's experience using a source company's sales software to increase sales.

One or more embodiments monitor news feeds or news websites for information associated with customer experience content. A news crawler bot analyzes and indexes content in news feeds. The system identifies semantic content in the news content. The system identifies a sentiment—whether positive or negative—associated with the news content. The system provides news content attribute data, including a sentiment score, to the machine learning model to generate the effectiveness score for a particular set of customer experience content.

One or more embodiments monitor a service request platform for information associated with customer experience content. When a customer encounters an issue with a company's product, the customer interacts with a service request platform to address the issue. For example, a customer may complain about a software platform that is not functioning as desired. As another example, a customer may request increased computing capacity in a cloud environment based on an increase in the customer's operations. The system detects new service requests associated with customer experience content. The system identifies semantic content in the service requests. For example, the system may identify the products associated with the service request. The system identifies a sentiment—whether positive or negative—associated with the service request. The system provides service request attribute data, which may include a sentiment score, to the machine learning model to generate the effectiveness score for a particular set of customer experience content.

One or more embodiments described in this Specification and/or recited in the claims may not be included in this General Overview section.

### 2. System Architecture

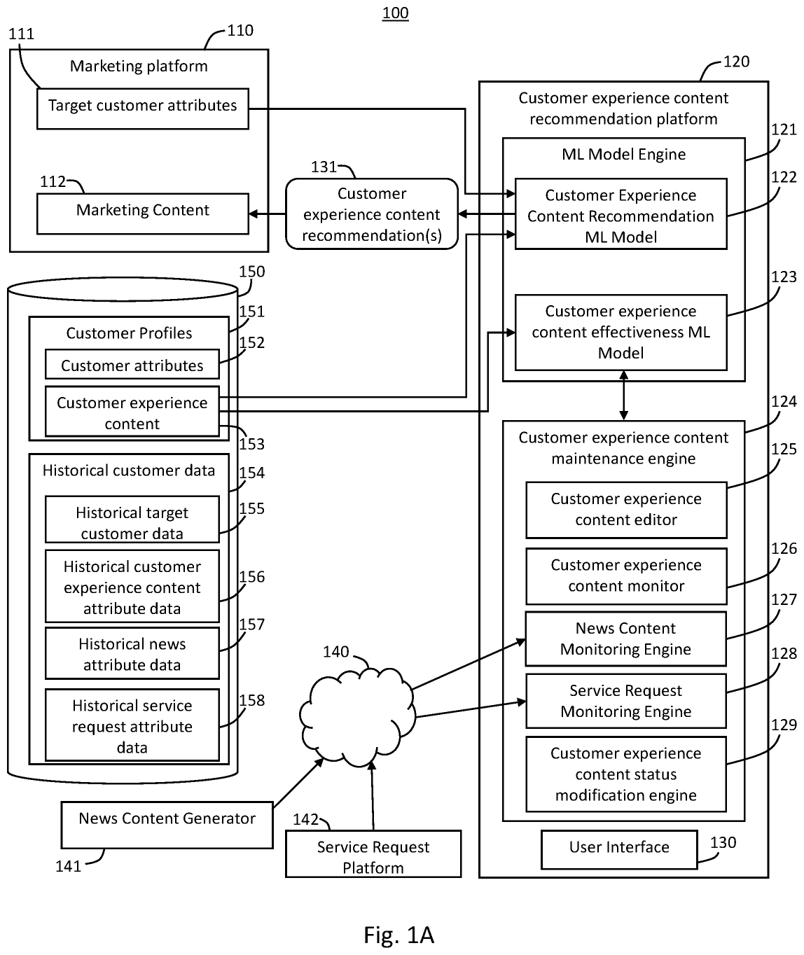

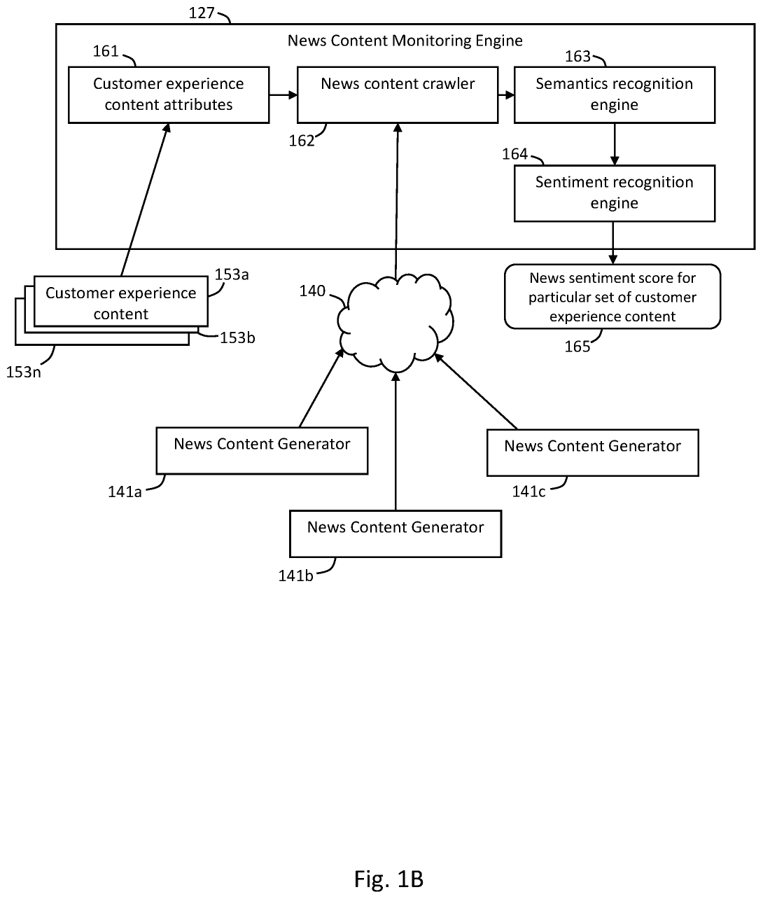

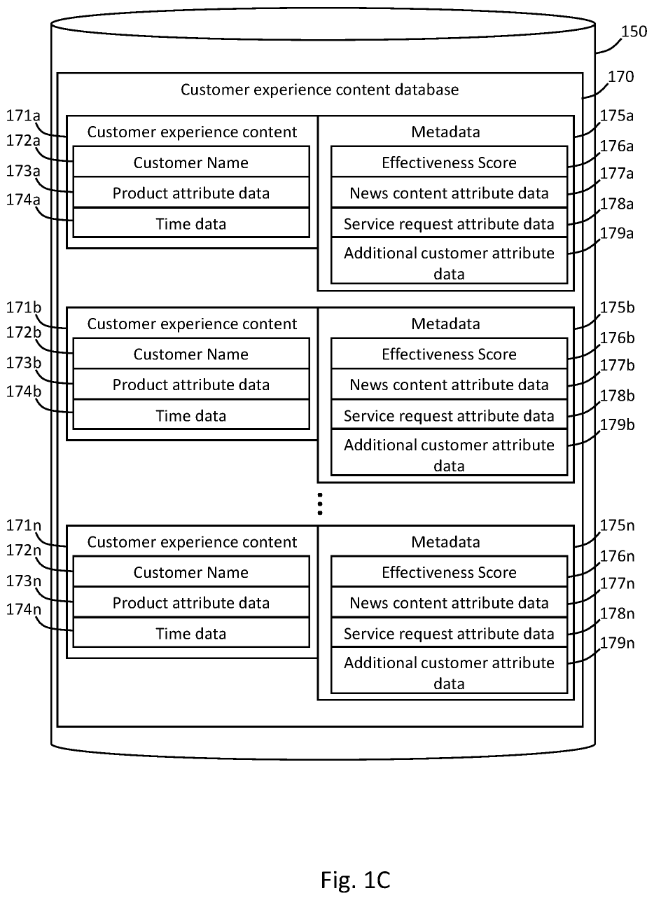

FIG. 1A illustrates a system 100 in accordance with one or more embodiments. As illustrated in FIG. 1A, system 100 includes a marketing platform 110, a customer experience content recommendation platform 120, a network 140, and a data repository 150. A marketing platform 110 is a platform used by a marketing entity to create and manage marketing content 112. For example, a marketing entity may include one or more of: a salesperson or team of salespersons, a customer service representative offering to upsell an existing client, or a service provider preparing a bid or pitch to a new or existing client. The marketing entity utilizes a marketing platform application to record customer acquisition opportunities. The customer may be a new customer that does not yet purchase goods and/or services from a goods/service provider associated with the marketing entity. Alternatively, the customer may be an existing customer to which a marketing entity is interested in selling additional goods and/or services. A marketing entity may enter into the marketing platform 110 target customer attributes 111. Example attributes include: a name, a type of business, products sold, products previously purchased, a number of employees, revenue, estimated profits, and any other data a marketing entity may consider relevant to record associated with a potential customer. While a marketing entity is one example of a source for target customer attributes, additional examples include: a computer-automated process, database queries, Internet website searches and Internet website crawlers, and data extracted from stored documents and files.

As an example of obtaining customer attributes, a salesperson may interface with a graphical user interface (GUI) including fields: “Opportunity Name”, “Company Name”, “Number of Employees”, “Company Revenue”, “Industry Type”, “Goods/Services Type”, “Goods/Services Previously Bought,” etc. The salesperson may enter the information for a particular company. Alternatively, the salesperson may upload content from a stored file to populate one or more fields of the GUI.

The marketing platform 110 provides a marketing entity with marketing content 112 to provide to a prospective customer. Marketing content 112 includes information about the source company and information about goods and/or services provided by the source company. In addition, the marketing content 112 includes customer experience content 153 associated with one or more existing or previous customers of the source company. According to one example, the customer experience content 153 includes a testimonial of an existing customer, describing the existing customer's experience with a good and/or service provided by the source company. For example, upon purchasing a human resources (HR) management application, a customer may generate a testimonial, such as: “We were growing each year, and our existing HR platform could not keep up. We purchased Platform Y by SourceCo., and we couldn't be more pleased. As we continue to grow year-over-year, we may worry about where to open up new markets for our products. But we have never had to worry about taking care of our people. Platform Y has taken all the worries out of taking care of our employees.”

According to another example, the marketing platform 110 accesses data in customer profiles 151, including customer attribute data 152, to match existing customers with a target customer. For example, a customer acquisition specialist may interface with a GUI to enter a size, industry type, and desired product type of a target customer into fields of a GUI. The marketing platform 110 may search customer profiles 151 stored in the data repository 150 to return existing customers that match the entered information. The customer acquisition specialist may generate a narrative based on the information obtained by the marketing platform 110. For example, a customer acquisition specialist may prepare a summary based on a template. The summary may include information, such as: “Company XYZ had 20 employees. In 2016, Company XYZ upgraded its HR Management Platform to Platform Y, by SourceCo. Now, in 2029, Company XYZ has 40 employees and continues to grow each year, thanks in part to Platform Y.”

While examples are provided in which customer experience content 153 includes narratives generated based on customer input or user input, one or more embodiments include customer experience content 153 that is made up of sets of data describing, in non-narrative form, a customer's experience.

A customer experience content recommendation platform 120 provides recommendations 131 to a marketing platform 110 of customer experience content to provide to a target customer associated with a marketing opportunity. According to one or more embodiments, a machine learning model engine 121 includes a customer experience content recommendation machine learning model 122. The customer experience content recommendation machine learning model 122 receives target customer attributes as input data. The customer experience content recommendation machine learning model 122 generates one or more customer experience content recommendations 131 as an output.

According to one embodiment, the machine learning model engine 121 trains the customer experience content recommendation machine learning model 122 based on pairs of: (a) historical target customer attributes 155, and (b) historical customer experience content attribute data 156. Each pair is further associated with (c) a target customer effectiveness score representing an effectiveness of providing a particular set of customer experience content to a particular target customer. The target customer effectiveness score may represent a correspondence of goods and/or services purchased by the historical target customers and the historical existing customers. The target customer effectiveness score may additionally, or in the alternative, represent a success rate of the target customer purchasing goods and/or services based on being provided with a set of customer experience content associated with the existing customer. For example, the machine learning model engine 121 may train the customer experience content recommendation machine learning model 122 with customer experience content attribute data that includes information about goods and services provided by an existing customer. The ML model engine 121 may further train the model 122 based on information about goods and services provided by a target customer. The ML model engine 121 may further train the model 122 based on data indicating that providing a particular set of historical customer experience content to a particular target customer in a marketing opportunity resulted in a sale of goods or services to the particular target customer.

The customer experience content recommendation machine learning model 122 may generate recommendations having one or more attributes that do not directly match the target customer attributes 111. For example, while the target customer attributes 111 may indicate the target customer has 50 employees, and while a customer profile 151 may exist with a company in the same industry with 50 employees, the machine learning model engine 121 may train the customer experience content recommendation machine learning model 122 to recognize an inverse correlation between goods/services utilized by the two companies. In addition, or in the alternative, the customer experience content recommendation machine learning model 122 may learn during training that there is a correlation between the goods/services purchased by the target company (having 50 employees) and a company of a customer profile 151 having 100 employees. In addition, or in the alternative, the customer experience content recommendation machine learning model 122 may learn during training that there is a correlation between the goods/services purchased by the target company associated with one industry and a company of a customer profile 151 in a different industry. In addition, or in the alternative, the customer experience content recommendation machine learning model 122 may learn during training that there is a correlation between the goods/services purchased by companies associated with a particular individual at different companies over different periods of time. Accordingly, the customer experience content recommendation machine learning model 122 may be trained to recommend particular goods/services to companies with which the particular individual is associated.

A marketing entity may obtain a recommendation for customer experience content 131 to provide to a prospective customer by providing to the customer experience content recommendation machine learning model 122 the target customer attributes 111. Upon receiving the target customer attributes 111, the customer experience content recommendation platform 120 may generate pairs made up of (a) the target customer attributes, and (b) customer attributes 152 and/or attributes associated with customer experience content of customer profiles 151 stored in the data repository 150. The customer experience content recommendation platform 120 provides the pairs to the customer experience content recommendation machine learning model 122 to generate respective target customer effectiveness scores for each pair. The system may recommend, as customer experience content recommendations, a predetermined number of sets of customer experience content 153 associated with the highest target customer effectiveness scores. For example, the customer experience content recommendation platform 120 may generate a group of ten sets of customer experience content 153, from among hundreds of sets of customer experience content, that are the most likely to result in a target customer purchasing a particular good and/or service.

The customer experience content 153 is stored in a data repository 150. The repository 150 may store a plurality of sets of customer experience content 153. The customer experience content recommendation machine learning model 122 obtains candidate sets of customer experience content from the plurality of sets of customer experience content 153 stored in the repository 150. In one or more embodiments, a data repository 150 is any type of storage unit and/or device (e.g., a file system, database, collection of tables, or any other storage mechanism) for storing data. Further, a data repository 150 may include multiple different storage units and/or devices. The multiple different storage units and/or devices may or may not be of the same type or located at the same physical site. Further, a data repository 150 may be implemented or may execute on the same computing system as the customer experience content recommendation platform 120. Alternatively, or additionally, a data repository 150 may be implemented or executed on a computing system separate from the customer experience content recommendation platform 120. A data repository 150 may be communicatively coupled to the customer experience content recommendation platform 120 via a direct connection or via a network.

Information describing customer profiles 151, customer attributes 152, customer experience content 153, and historical customer data 154 may be implemented across any of components within the system 100. However, this information is illustrated within the data repository 150 for purposes of clarity and explanation.

Based on the recommended customer experience content 131, a marketing entity may select customer experience content 153 to provide to a target customer in a sales pitch or a bid to provide goods and/or services. For example, the marketing platform 110 may generate electronic or physical content (such as a pamphlet) including marketing content 112 with narrative and/or non-narrative customer experience content from existing customers to provide to the target audience in a marketing opportunity.

The machine learning model engine 121 includes a customer experience content effectiveness machine learning model 123. The customer experience content effectiveness machine learning model 123 generates a customer experience content effectiveness score (described herein as an “effectiveness score”) for a particular set of customer experience content based on customer experience content attributes. The customer experience content attributes may include, for example, a customer identity, a product associated with the customer, and data associated with a description of a customer experience with the product at a particular period of time. The customer experience content attributes may further include one or both of: news account data corresponding to a news account associated with the customer and the particular period of time, and service request data corresponding to one or more of a number, type, and resolution state of service requests by the customer to a service provider associated with the product.

The machine learning model engine 121 trains the machine learning model 123 based on historical customer data 154. In particular, the machine learning model engine 121 generates a training data set including: (a) historical customer experience content attribute data 156, and (b) an effectiveness score associated with the historical customer experience content attribute data 156. The training data set may further include one or both of: (a) historical news attribute data 157 associated with a particular set of historical customer experience content attribute data 156, and (b) historical service request attribute data 158 associated with the particular set of historical customer experience content attribute data 156.

While the customer experience content recommendation machine learning model 122 and the customer experience content effectiveness machine learning model 123 are illustrated as separate machine learning models in FIG. 1, in one or more embodiments the models may be combined into a composite machine learning model. For example, the composite machine learning model may receive as input data both the target customer attributes and the customer experience content attributes. The composite machine learning model may generate a target customer effectiveness score associated with a pair of (a) a particular set of customer experience content for which the attribute data was provided as an input to the composite machine learning model, and (b) the particular target customer for which the attributes were provided as input data to the composite machine learning model. The target customer effectiveness score may represent an effectiveness of providing a particular set of customer experience content 153 to a particular target customer.

A customer experience content maintenance engine 124 includes hardware and/or software to obtain and manage data associated with customer experience content. The customer experience content maintenance engine 124 includes a customer experience content editor 125. A user may interface with a GUI generated by the customer experience content editor 125 to update and modify a set of customer experience content 153. For example, a user may generate a testimonial for a customer based on a customer's experience purchasing goods and/or services. After a time, a user may update a testimonial based on a change in data associated with the customer. For example, if an initial testimonial describes the customer as having 10 employees, a user may modify the testimonial after a period of time has passed to indicate the customer has 50 employees. Similarly, a user may modify customer experience content to describe a positive result associated with purchasing goods and/or service. If, after a year of using a software product, a customer realizes increased profits, a user may update the customer experience content associated with the customer and the product to indicate the positive result of increased profits associated with the customer experience. In addition, or in the alternative, a user may interface with the customer experience content editor 125 to update fields in tables. For example, a table may include the fields “name” “product” “employees” “industry” “year 1 sales” “year 2 sales” “year 3 sales” “customer comment”. A user may update values in one or more fields or add values in one or more fields based on the passage of time and changes in customer attributes. In addition to user-provided edits, a computer may edit customer experience content without user intervention. For example, a system may monitor a contract duration and modify, without user intervention, metadata associated with customer experience content to indicate a contract has expired or terminated.

As another example, a cloud-based management engine may monitor traffic to a customer's web page. The cloud-based management engine may provide to the customer experience content editor 125 traffic data. If the customer experience content editor 125 detects that traffic to a customer's webpage has increased over time subsequent to implementing a source company's product, the customer experience content editor 125 may generate values in fields of a table representing a set of customer experience content 153 to reflect the increase in traffic to the customer's website subsequent to the customer implementing the source company's product. According to yet another example, a cloud-services provider (CSP) may monitor productivity metrics associated with a customer. Examples of productivity measurements may include: interruptions to user applications based on cloud delays or interruptions, latency in a cloud environment, growth in a cloud environment, such as by expanding resources in the cloud environment, and quantities of data managed in a cloud environment. The CSP may provide to the customer experience content editor 125 productivity data for a particular customer. If the customer experience content editor 125 detects changes to a customer's productivity over time, in connection with one or more goods/services provided by the CSP, the customer experience content editor 125 may generate values in fields of a table representing a set of customer experience content 153 to reflect the changes to the customer's productivity over time, in connection with one or more goods/services provided by the CSP.

According to yet another example, the system 100 may monitor product data and determine that the product associated with the customer experience content is no longer sold. The system 100 may update metadata associated with the customer experience content to indicate the product described in the customer experience content is no longer available. According to yet another example embodiment, the system may monitor customer information to determine that the customer associated with a particular set of customer experience content 153 is no longer a customer of the marketing entity.

In an example in which the customer experience content is a narrative of the customer experience, the customer experience content recommendation platform 120 may store metadata in the repository 150 in association with the narrative content without being displayed together with the narrative content when the narrative content is displayed to a marketing entity. For example, a narrative may include a human-understandable testimonial, such as: “We purchased product X from SourceCo. to reign in costs that seemed to be constantly increasing . . . .” The customer experience content recommendation platform 120 may store metadata, mapped to the testimonial, representing: a size of the customer, an industry in which the customer operates, additional goods/services purchased by the customer, contract terms (such as price, quantity, and contract duration) associated with goods/services purchased by the customer, etc.

A customer experience content monitor 126 monitors customer experience content to detect changes in the customer experience content. The changes may be based on user modifications to the customer experience content or based on computer-generated changes, as discussed above.

A news content monitoring engine 127 monitors news content in one or more news content generators 141. As illustrated in FIG. 1B, the news content monitoring engine 127 may extract customer experience content attributes 161 from sets of customer experience content 153a-153n. For example, the news content monitoring engine 127 may extract customer names, products purchased by customers, and an industry in which a customer operates from the sets of customer experience content 153a-153n. The news content monitoring engine 127 includes a news content crawler 162. The news content crawler 162 may be a plugin, a bot, or an application that monitors news content generators 141a-141c over a network 140, such as the Internet. The news content generators 141a-141c may include news websites, news feeds, social media feeds, and articles published to a company's website, for example. The news content crawler 162 may monitor news stories on news feeds for key words based on the customer experience content attributes 161 extracted from the sets of customer experience content 153a-153n. The news content monitoring engine 127 includes a semantics recognition engine 163. The semantics recognition engine 163 may identify semantic content in the news stories including meanings and topics associated with words, sentences, and paragraphs. The news content monitoring engine 127 may further include a sentiment recognition engine 164. The sentiment recognition engine 164 analyzes the semantic content associated with relevant news stories, such as news stories mentioning a customer name, to identify the sentiment associated with the news story. The sentiment recognition engine 164 generates a sentiment score 165 for a particular news story and associates the sentiment score with a particular set of customer experience content (among the sets 153a, 153b, . . . 153n from which the content attributes 161 were extracted).

For example, a news story about a financial recession may mention a particular customer as filing for bankruptcy. The semantics recognition engine 163 identifies the story as being associated with the customer and bankruptcy. The sentiment recognition engine 164 may label the sentiment associated with the news story as “negative” in connection with a particular set of customer experience content associated with the particular customer. Alternatively, a news story may mention quarterly revenues for a particular customer exceeding expectations. The sentiment recognition engine 164 may label the sentiment associated with the news story as “very positive” in connection with a particular set of customer experience content associated with the particular customer. The sentiment labels representing negative, positive, or neutral sentiment may be represented as numerical scores, such as a value within a range from 0 to 1, 1 to 10, or any other predefined range of values.

The news content monitoring engine 127 may provide news content attribute data, such as a sentiment score associated with particular customer experience content, to the customer experience content effectiveness machine learning model 123. In addition, or in the alternative, the system may store news content attribute data in association with its corresponding set of customer experience content 153. Based on a triggering event, the system may provide the customer experience content attribute data and one or more sets of news content attribute data to the customer experience content effectiveness machine learning model 123 to generate an effectiveness score associated with a set of customer experience content 153.

A service request monitoring engine 128 monitors a service request platform 142 for service requests associated with customer experience content 153. The service request monitoring engine 128 may include a plugin that monitors the content of service requests generated by users, customers, or by computer applications. For example, a customer may generate a service request in a service request platform 142 based on a software product that is not performing to specification. The service request platform 142 may generate a service request ticket. A technician may diagnose and remediate issues identified by service request tickets. The technician may then clear service request tickets to indicate particular issues have been diagnosed and/or remediated. The service request monitoring engine 128 may monitor service requests or tickets for key words associated with customer experience content 153. Examples of the types of keywords that the service request monitoring engine 128 may look for include customer names of customers associated with customer experience content and product names. The service request monitoring engine 128 may include a semantics recognition engine. The semantics recognition may identify semantic content in the service requests including meanings and topics associated with words, sentences, and paragraphs. The service request monitoring engine 128 may further include a sentiment recognition engine. The sentiment recognition engine analyzes the semantic content associated with relevant service requests, such as service requests originated by a particular customer, to identify the sentiment associated with the service request. For example, a service request may include content describing a software flaw or malfunction. The sentiment recognition engine may label the sentiment associated with the service request as “negative” in connection with a particular set of customer experience content associated with the particular customer. Alternatively, a service request may include a request for an upgrade or a request to increase usage of a particular product. The sentiment recognition engine may label the sentiment associated with the service request as “positive” in connection with a particular set of customer experience content associated with the particular customer. The sentiment labels representing negative, positive, or neutral sentiment may be represented as numerical scores, such as a value within a range from 1 to 10. The service request monitoring engine 128 may provide service request attribute data, such as a sentiment score associated with particular customer experience content, and a number of service requests, to the customer experience content effectiveness machine learning model 123.

In addition, or in the alternative, the system may store service request attribute data in association with its corresponding set of customer experience content 153. Based on a triggering event, the system may provide the customer experience content attribute data and one or more sets of service request attribute data to the customer experience content effectiveness machine learning model 123 to generate an effectiveness score associated with a set of customer experience content 153.

According to one embodiment, one or both of the news content monitoring engine 127 and the service request monitoring engine 128 generates news content attribute data or service request attribute data to modify customer experience content 153. For example, customer experience content 153 may describe a customer associated with one industry and news content may indicate the customer is expanding to another industry. The news content monitoring engine 127 may generate news content attribute data indicating the customer is associated with the second industry. The customer experience content editor 125 may add the news content attribute data to the customer experience content 153. In the event the customer experience content 153 is provided as input data to the machine learning models 122 or 123 to generate a target customer effectiveness score or customer experience content effectiveness score, respectively, the news content attribute data may be included among the data provided to the machine learning models 122 and 123.

According to one or more embodiments, one or both of news content attribute data and service request attribute data are provided to machine learning models 122 and 123 separately from related customer experience content 153. For example, input data provided to the customer experience content effectiveness machine learning model 123 may be obtained from one data storage location associated with the customer experience content 153 and from another data storage location associated with the news content attribute data.

According to one or more embodiments, one or more of the customer experience content editor 125, the news content monitoring engine 127, and the service request monitoring engine 128 may trigger application of the customer experience content effectiveness machine learning model 123 to generate a new effectiveness score for a particular set of customer experience content 153. For example, the customer experience content monitor 126 may detect a modification to the customer experience content 153 indicating a customer contract associated with a product will expire in a month. The customer experience content recommendation platform 120 may provide the modified customer experience content 153, including attribute data associated with the contract expiration, to the customer experience content effectiveness machine learning model 123. As a result, the machine learning model 123 may generate a lower effectiveness score for the customer experience content 153 than the model 123 would generate when a contract is not near expiration. The lower effectiveness score reflects a decrease in value in providing, by a marketing entity, the customer experience content that will soon be obsolete to a prospective customer.

According to another example, the news content monitoring engine 127 may detect a trigger, such as (a) a number of news stories associated with customer experience content that exceeds a threshold, and/or (b) a sentiment score of one or more news stories that exceeds a threshold. The customer experience content recommendation platform 120 may provide a set of customer experience content 153 and a set of news content attribute data to the machine learning model 123 to generate an effectiveness score for the costumer experience content 153. If a sentiment score of the news content is positive, the model 123 may generate a higher effectiveness score than the previous effectiveness score. If the sentiment score of the news content is negative, the model 123 may generate a lower effectiveness score than the previous effectiveness score.

According to another example, the service request monitoring engine 128 may detect a trigger, such as (a) a number of service requests associated with customer experience content that exceeds a threshold, and/or (b) a sentiment score of one or more service requests that exceeds a threshold. The customer experience content recommendation platform 120 may provide the customer experience content 153 and a set of service request attribute data to the machine learning model 123 to generate an effectiveness score for the costumer experience content 153. If a sentiment score of the service requests is positive, the model 123 may generate a higher effectiveness score than the previous effectiveness score. If the sentiment score of the service requests is negative, or if the number of service requests exceeds a threshold, the model 123 may generate a lower effectiveness score than the previous effectiveness score.

A customer experience content status modification engine 129 includes hardware and/or software for analyzing an effectiveness score and determining whether to perform remediating action.

A customer experience content status modification engine 129 analyzes an effectiveness score for a particular set of customer experience content 153. The customer experience content status modification engine 129 determines whether to perform one or more remedial operations based on the effectiveness score. According to one or more embodiments, the customer experience content status modification engine 129 compares the effectiveness score for a particular set of customer experience content 153 to one or more threshold values to determine an action to perform associated with a particular set of customer experience content. The customer experience content status modification engine 129 may compare an effectiveness score to a first threshold value to determine whether to purge the set of customer experience content from among the customer profiles 151.

For example, an initial set of customer experience content 153 may describe a positive customer experience with a rollout of a software platform for a customer with 50 employees. However, a series of subsequent service requests may indicate problems with the rollout. In addition, a news story may indicate a reduction in employees from 50 to 25. Accordingly, a customer experience content effectiveness machine learning model 123 may generate a low effectiveness score associated with the particular customer experience content 153, indicting the particular customer experience content describing the positive software platform rollout is no longer effective for marketing to a prospective customer. The customer experience content status modification engine compares the effectiveness score to the threshold value, and determines that the customer experience content should be purged from the repository of customer experience content associated with a plurality of customers and customer experiences with goods and/or services. Accordingly, the particular set of customer experience content describing the positive customer experience with a software rollout would be removed from the repository. As a result, it would not be available to a marketing entity to provide to a prospective customer as marketing content.

According to one or more embodiments, the customer experience content status modification engine 129 may compare an effectiveness score for a particular set of customer experience content to a plurality of threshold values. If the effectiveness score is less than a first threshold, the customer experience content status modification engine 129 may purge the content from a repository of customer experience content available for a marketing platform. If the effectiveness score is equal to, or greater than, the first threshold, and less than a second threshold, the customer experience content status modification engine 129 may generate a notification for a user to review the content. Alternatively, the customer experience content status modification engine 129 may designate the content as being unavailable for marketing for a predetermined period of time. If the effectiveness score is equal to, or greater than, the second threshold, the customer experience content status modification engine 129 may keep the customer experience content in the repository of content available to a marketing platform for marketing to prospective customers.

As discussed above, the customer experience content recommendation machine learning model 122 recommends to a marketing platform 110 customer experience content 131 for including in marketing content to a particular target customer. When the customer experience content status modification engine 129 purges a set of customer experience content 153 from the repository of sets of customer experience content available to the marketing platform 110, the purged set of customer experience content 153 is not available to the customer experience content recommendation machine learning model 122 as a candidate set of customer experience content for recommending to a marketing platform 110. Likewise, if the customer experience content status modification engine 129 sets a status of a set of customer experience content to “unavailable for a predetermined period of time,” the set of customer experience content 153 is temporarily made unavailable to the customer experience content recommendation machine learning model 122 as a candidate set of customer experience content for recommending to a marketing platform 110.

While the above description provides an example of the customer experience content status modification engine 129 comparing an effectiveness score to thresholds to determine a remedial action to apply to a set of customer experience content, it is understood that the customer experience content status modification engine 129 may perform a similar analysis with a target customer effectiveness score. According to one example, purging customer experience content based on a low effectiveness score removes the customer experience content from a repository of sets of customer experience content available to a marketing platform. According to another example, purging customer experience content based on a low target customer effectiveness score prevents a marketing platform from using a particular set of customer experience content as marketing content for a particular target customer. According to one example, setting a non-use time window, in which customer experience content may not be used by a marketing platform, based on a particular effectiveness score prevents the marketing platform from using the customer experience content for any target customers. According to another example, setting a non-use time window, in which customer experience content may not be used by a marketing platform, based on a particular target customer effectiveness score prevents the marketing platform from using the customer experience content for the particular target customer. The customer experience content may still be available to the marketing platform to provide to different target customers.

According to one or more embodiments, the customer experience content 153 may be stored together with associated metadata in a database. FIG. 1C illustrates an example of a customer experience content database 170 stored in the repository 150. The customer experience content database 170 stores customer experience content 171a-171n. The customer experience content 171a-171n corresponds to the customer experience content 153 illustrated in FIG. 1A. The customer experience content 171a-171n may include narrative customer experience content, such as a testimonial or case study. As an example, a testimonial describes a customer's experience with a product from the customer's perspective (e.g., “Our company needed a solution for our growing cloud presence . . . ”). A case study may describe a customer's experience with a product from a third-person perspective (e.g., “Customer X needed solutions for a growing cloud presence . . . ”) According to another example, the customer experience content 171a-171n is stored in a table format with fields storing values associated with customer data, product data, and time data associated with a time when the customer purchased or used a particular product. The customer experience content 171a includes a customer name 172a, product attribute data 173a, and time data 174a. A single customer may be associated with multiple sets of customer experience content, among sets 171a-171n. In addition, different sets of customer experience content among the sets 171a-171n may be associated with different customers. For example, one customer may be associated with three sets of customer experience content based on purchasing three different products from a source company. Another customer may be associated with five different sets of customer experience content based on purchasing five different products from the source company.

Each set of customer experience content 171a-171n includes at least (a) a customer name 172a-172n, product data 173a-173n, and time data 174a-174n. For example, a customer testimonial may describe the customer purchasing a product at a particular time. According to one or more embodiments, a customer name may be anonymized in marketing content. For example, instead of marketing content describing “customer X” purchasing 50 units of a product, the marketing content may describe “a Fortune 500 company purchased 50 units of the product . . . .” The product attribute data 173a-173n may include: product name, product type, product class, product price, product availability, product specification (such as for a customized software platform), etc. The time data 174a-174n may include: a date when a product was purchased, a duration of a contract associated with the product, and a duration of time that a particular product is valid.

The customer experience content database 170 stores metadata 175a-175n associated with the sets of customer experience content 171a-171n. The metadata 175a-175n includes, for each set of customer experience content 171a-171n, respectively, an effectiveness score 176a-176n, news content attribute data 177a-177n, and service request attribute data 178a-178n. The metadata 175a-175n also includes additional customer attribute data 179a-179n associated with a customer that may not be included in narrative content of a narrative customer experience content 171a-171n. For example, if customer experience content 171a is a testimonial of a customer describing the customer's experience with a product, the additional customer attribute data 179a may include information not included in the testimonial, such as a number of employees, an industry in which the customer operations, geographic regions in which the customer operates, annual revenue, other products purchased by the customer from the company, and any other information relevant to an effectiveness of the customer experience content 171a that is not included in narrative content of the customer experience content 171a. The metadata 175a-175n includes data that contributes to one or both of: (a) a recommendation of a particular set of customer experience content for a target customer and (b) a calculation of an effectiveness score for a set of customer experience content. However, the metadata may not be included in the customer experience content. For example, customer experience content may include a narrative that “Company X rolled out software product Y in 2001 and saw a 10% improvement in revenues the next year.” The metadata may include an effectiveness score of 5 associated with the customer experience content, news content attribute data associated with seven news stories associated with Company X, and service request attribute data indicating Company X generated 50 service requests associated with the rollout and operation of software product Y. The effectiveness score, the news content attribute data, and the service request attribute data may not be included in the narrative customer experience content. However, the effectiveness score, the news content attribute data, and the service request attribute data may contribute to one or both of: (a) a recommendation of a particular set of customer experience content for a target customer and (b) a calculation of an effectiveness score for the set of customer experience content.

According to one or more embodiments, machine learning model engine 121 obtains sets of customer experience content 171a-171n from the customer experience content database 170 to provide input data to one or more machine learning models to generate one or both of a recommendation for customer experience content 131 for a target customer or to generate an effectiveness score for a particular set of customer experience content 171a-171n in the database 170.

In one or more embodiments, the system 100 may include more or fewer components than the components illustrated in FIGS. 1A-1C. The components illustrated in FIGS. 1A-1C may be local to or remote from each other. The components illustrated in FIGS. 1A-1C may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 7, titled “Computer Networks and Cloud Networks.”

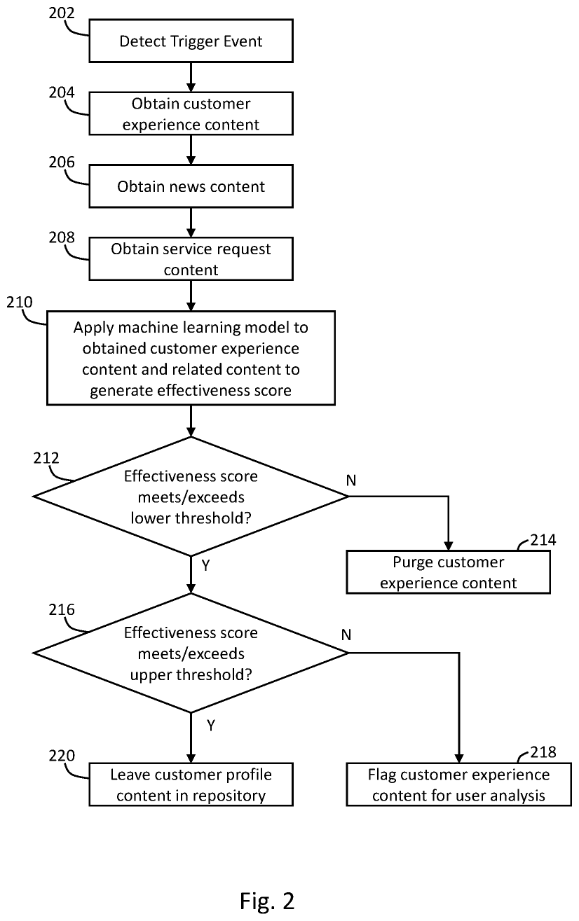

In one or more embodiments, a customer experience content recommendation platform 120 refers to hardware and/or software configured to perform operations described herein for (a) applying one or more machine learning models to customer experience content and additional attribute data, (b) monitoring news content generators and service request platforms, and (c) modifying a status of stored customer experience content. Examples of operations for (a) applying one or more machine learning models to customer experience content and additional attribute data, (b) monitoring news content generators and service request platforms, and (c) modifying a status of stored customer experience content are described below with reference to FIG. 2.

In an embodiment, a customer experience content recommendation platform 120 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, interface 130 refers to hardware and/or software configured to facilitate communications between a user and the customer experience content recommendation platform 120. Interface 130 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 130 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 130 is specified in one or more other languages, such as Java, C, or C++.

### 3. Managing Customer Experience Content

FIG. 2 illustrates an example set of operations for managing customer experience content in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

A system detects a trigger event (Operation 202). The trigger event triggers the generation or re-generation of an effectiveness score associated with customer experience content. Examples of triggers include: detecting a new news article associated with a customer, detecting a new service request associated with the customer, detecting a change to customer experience content associated with the customer, detecting an expiration of a contract associated with customer experience content, and detecting a predetermined period of time has elapsed associated with a regularly-scheduled re-calculation of an effectiveness score.

Based on detecting the trigger event, the system obtains a set of customer experience content (Operation 204). The customer experience content describes a customer experience with a particular product associated with a particular period of time. For example, the customer experience content may be a testimonial: “We needed a cloud services platform that would meet the needs of our growing data requirements . . . .” As another example, the customer experience content may be a case study: “Company X needed a cloud services platform that would meet the needs of their growing data requirements . . . .” As another example, the customer experience content may be a non-narrative data set: “Customer Name: Company X; Product: ProductY; Purchase Date: January 2022; Observed Results: 10% increase in productivity over one year . . . .” The system may extract semantic content from the customer experience content. For example, a narrative-type set of customer experience content may include customer information, product information, and information describing the customer's feelings regarding the product and the source company. The system may identify from the customer experience content a set of attributes associated with the customer experience content. The attributes may include the content itself, such as a customer name. The system may also identify a sentiment associated with the customer experience content. For example, a narrative-type set of customer experience content may describe a customer feeling extremely satisfied with their experience rolling out product X from source company Y. The system may obtain data associated with the sentiment of the customer experience content.

In addition to obtaining the customer experience content, the system may obtain additional content relevant to the customer experience content. According to one or more embodiments, the system obtains news content (Operation 206). The system may include a news content crawler, such as a news feed bot. The news content crawler may identify and index content on news websites, news feeds, social media feeds, and articles published to a company's website. The news content crawler identifies news stories associated with the customer experience content. The news content crawler may scan the content of news stories for key words based on the customer experience content. The system identifies semantic content in the news stories including meanings and topics associated with words, sentences, and paragraphs. The system analyzes the semantic content associated with relevant news stories, such as news stories mentioning a customer name, to identify the sentiment associated with the news story. The system generates a sentiment score for the news story based on the sentiment associated with the semantic content in the news story.

For example, a news story about a financial recession may mention a particular customer as filing for bankruptcy. The system identifies the story as being associated with the customer and bankruptcy. The system may generate a low sentiment score associated with the story based on the negative sentiment in the news story. Alternatively, a news story may mention quarterly revenues for a particular customer exceeding expectations. The system may generate a high sentiment score associated with the story based on the positive sentiment in the news story

According to one or more embodiments, obtaining additional content relevant to customer experience content includes obtaining service request content (Operation 208). The system monitors a service request platform for service requests associated with customer experience content. The system may obtain service request data using a plugin installed in the service request platform. The plugin monitors the content of service requests generated by users, customers, or by computer applications. For example, a customer may generate a service request in a service request platform based on a software product that is not performing to specification. The service request platform may generate a service request ticket. A technician may diagnose and remediate issues identified by service request tickets. The technician may then clear service request tickets to indicate particular issues have been diagnosed and/or remediated. The service request monitoring engine may monitor service requests or tickets for key words associated with customer experience content. Examples of the types of keywords that the service request monitoring engine may look for include customer names of customers associated with customer experience content and product names. The system may identify semantic content in the service requests including meanings and topics associated with words, sentences, and paragraphs. The system may analyze the semantic content associated with relevant service requests, such as service requests originated by a particular customer, to identify the sentiment associated with the service request. For example, a service request may include content describing a software flaw or malfunction. The sentiment recognition engine may generate a low sentiment score in connection with the service request based on the negative content of the service request. Alternatively, a service request may include a request for an upgrade or a request to increase usage of a particular product. The system may generate a high sentiment score associated with the service request based on the positive sentiment associated with the service request

According to one or more embodiments, the system obtains news content and/or service request content, without proceeding to operation 210, until a threshold is met. For example, a threshold may comprise an aggregate score including: a score representing attributes of customer experience content, a score representing modifications to the customer experience content, a score representing: (a) a number of news stories, and (b) sentiment scores associated with the news stories, and a score representing: (a) a number of service requests, and (b) sentiment scores associated with the service requests. When the system determines the aggregate score based on the customer experience content attributes and any additional content attributes meets the threshold, the system may proceed to generate an effectiveness score for customer experience content in operation 210.

The system applies a machine learning model to customer experience content attribute data and to related content attribute data to generate an effectiveness score for the customer experience content (Operation 210). The system provides to the machine learning model attribute data associated with a customer identity, a product associated with the customer, and data associated with a description of a customer experience with the product at a particular period of time. The system may further provide to the model one or both of attribute data associated with the news content and the service request content.

According to one embodiment, the machine learning model is trained to generate an effectiveness score based on the customer experience content attribute data, the news content attribute data, and the service request attribute data, independent of any particular target customer. In this embodiment, the effectiveness score indicates whether a particular set of customer experience content is suitable for use in any marketing content to any potential customers. According to another embodiment, the system provides as input data to the machine learning model attribute data associated with a particular target customer. The machine learning model may generate a particular effectiveness score that indicates whether the customer experience content is effective as marketing content for the particular target customer.

The system compares the effectiveness score for a particular set of customer experience content to a set of thresholds to determine one or more actions to take corresponding to the customer experience content. As illustrated by Operation 212, the system determines whether the effectiveness score meets or exceeds a lower threshold. For example, the machine learning model may generate an effectiveness score between 0 and 10. A lower threshold may be set to “4.” The lower threshold may be set by a user or administrator, for example.

If the effectiveness score does not meet or exceed the lower threshold, the system purges the customer profile content (Operation 214). Purging the customer profile content includes deleting electronically stored data from a repository. For example, the system may maintain a database of narrative and non-narrative customer profile content. When a marketing opportunity is detected, the system may access the database to identify the customer experience content to provide to a prospective customer to increase a likelihood of success in the marketing opportunity. Purging the customer profile content may include deleting the customer profile content from the database of sets of customer profile content. As a result, the purged customer profile content is unavailable for any future marketing opportunities.

If the effectiveness score exceeds the lower threshold, the system determines whether the effectiveness score meets or exceeds an upper threshold (Operation 216). For example, if the machine learning model generates an effectiveness score in a range between 0 and 10. An upper threshold may be set to “7.” Based on determining the effectiveness score meets or exceeds the lower threshold but does not meet the upper threshold, the system flags customer experience content for user analysis (Operation 218). According to one example, the system omits the particular customer experience content from a collection of sets of customer experience content available to a marketing platform until user input is received associated with flagged customer experience content. According to another embodiment, instead of flagging customer experience content for user review, the system may disable use of the customer experience content for a predetermined period of time. Making the customer experience content unavailable for use may include omitting a particular set of customer experience content from a collection of customer experience content available to a marketing platform to provide to a potential customer. The system may determine at the conclusion of a predetermine period of time whether the effectiveness score has changed for the customer experience content. For example, the system may detect negative news content associated with customer experience content, resulting in a lower effectiveness score. The system may set a time for any particular news story to influence an effectiveness score at three months. At the end of three months, the system may omit attribute data for the news story from the input to the machine learning model to calculate the effectiveness score.

Alternatively, the system may omit the attribute data for the news story from the input to the machine learning model only if no additional negative news content has been detected during the period of time in which the customer experience content was made unavailable to a marketing platform. For example, if the system prevents a marketing platform from using a particular set of customer experience content for three months, the system may determine at the end of the three months if additional negative news content has been generated in connection with the customer experience content. If the system determines that, during the three months, no additional negative news content has been generated, the system may recalculate the effectiveness score at the end of three months without including attribute data from the negative news article. While examples are described above in the context of news content, it is understood that the system may perform similar actions associated with service requests. For example, the system may calculate a lower effectiveness score at a certain time based at least in part on ten service requests generated within the previous three months in connection with a particular set of customer experience content associated with a customer's purchase of a product. The system may recalculate a higher effectiveness score at a later time based at least in part on detecting only two additional service requests within a period of six months.

If the effectiveness score meets or exceeds the upper threshold, the system leaves the customer profile content in the repository of sets of customer profile content (Operation 220). For example, the customer profile content that is left in the repository may be accessed by a marketing platform to generate a pitch for a prospective customer.

### 4. Training Machine Learning Model to Generate an Effectiveness Score for Customer Experience Content

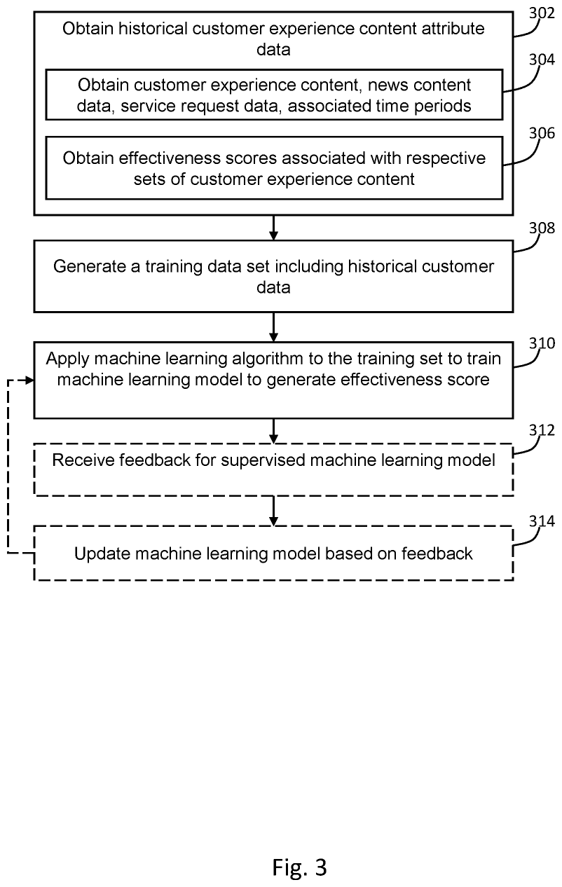

FIG. 3 illustrates an example set of operations for training a machine learning model to generate an effectiveness score for a set of customer experience content, in accordance with one or more embodiments. In one or more embodiments, a set of customer experience content is a narrative account of a customer experience with a product, such as a testimonial. According to another embodiment, the set of customer experience content is non-narrative a set of data including customer identification information, product information, and information associated with a customer experience with the product. A system obtains historical customer experience content attribute data (Operation 302). The historical customer experience attribute data includes data obtained from historical customer experience content, news content data, service request data, and time data associated with the customer experience content (Operation 304). The historical customer data also includes historical effectiveness scores associated with respective sets of historical customer experience content (Operation 306). For example, the system may identify a repository of narrative customer experience content, such as a repository of customer testimonials. The repository may include a variety of testimonials, associated with a variety of products and a variety of customers. The narrative content of the testimonials includes a customer name, a product purchased by the customer, and a description of a positive customer experience associated with purchasing the product. The system may extract semantic content—such as customer, product, and time information—from the narrative content of the testimonials. The system may also obtain metadata associated with the narrative content. The metadata may include, for example, a customer size, customer industry, products or services sold or provided by the customer, employee information, geographical information, revenue data, competitor data, etc.

The system generates a training set including the historical customer data (Operation 308). The training data set includes, for multiple customers and products, (a) customer experience content attribute data associated with a set of customer experience content, and (b) an effectiveness score associated with the set of customer experience content.

The system applies a machine learning algorithm to the training data set (Operation 310). The machine learning algorithm analyzes the training data set to identify data and patterns that indicate relationships between customer experience content attributes and effectiveness scores associated with the corresponding customer experience content. For example, the machine learning algorithm may train a machine learning model to generate a relatively lower effectiveness score based on negative news content associated with a set of customer experience content. In addition, or in the alternative, the machine learning algorithm may train a machine learning model to generate a relatively lower effectiveness score based on a high number of service requests received associated with a particular set of customer experience content. In addition, or in the alternative, the machine learning algorithm may train the machine learning model to generate a relatively higher effectiveness score based on a user update to narrative content in the customer experience content indicating improved productivity since the initial purchase of a product.

In examples of supervising ML algorithms, the system may obtain feedback on the whether a particular effectiveness score should be applied to a particular set of customer experience content (Operation 312). The feedback may affirm that a particular feedback score is appropriate for a particular set of customer experience content. In other examples, the feedback may indicate that a particular effectiveness score should not be associated with a particular set of customer experience content. Based on the feedback, the machine learning training set may be updated, thereby improving its analytical accuracy (Operation 314). Once updated, the system may further train the machine learning model by optionally applying the model to additional training data sets.

An example is provided above for training a machine learning model to generate an effectiveness score for customer experience content based on at least: attributes of the customer experience content, and optionally news content data and service request data. According to another embodiment, the machine learning algorithm trains the machine learning model based on at least: (a) customer experience content attribute data and (b) target customer attribute data, and optionally, one or both of (a) news content data and (b) service request data. In this embodiment, the machine learning algorithm trains the machine learning model to generate an effectiveness score indicating an effectiveness of providing to a customer having the target customer attributes the customer experience content having the customer experience content attributes. For example, the machine learning model may be trained to identify companies of a particular size are more likely to purchase a particular product associated with customer experience content describing an experience of a same-sized company. In addition, or in the alternative, the machine learning model may be trained to identify companies within a particular industry are more likely to purchase a particular product associated with customer experience content describing an experience of another company in the same industry.

### 5. Training Machine Learning Model to Recommend Customer Experience Content for a Target Customer

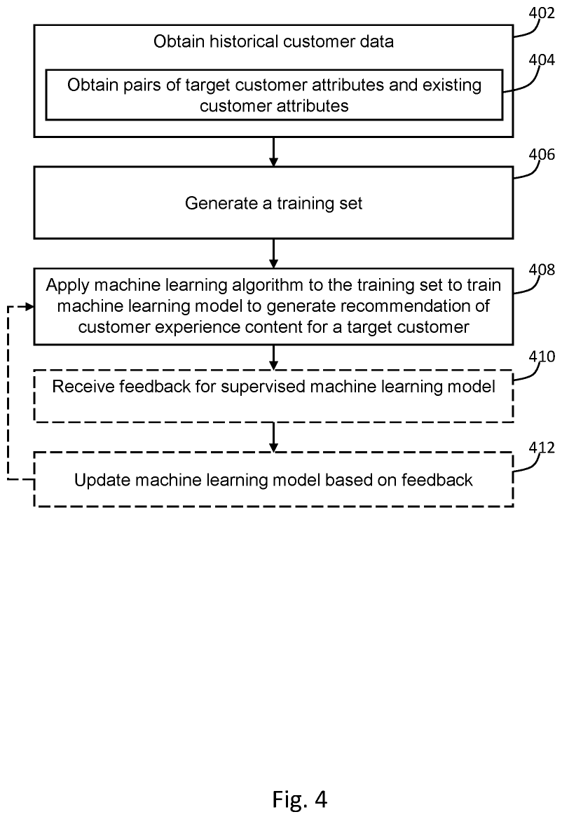

FIG. 4 illustrates an example set of operations for training a machine learning model to recommend customer experience content for a particular target customer, in accordance with one or more embodiments. A system obtains historical customer data (Operation 402). Obtaining historical customer data includes obtaining pairs of existing-customer attribute data and target customer attribute data (Operation 404). The customer attribute data includes, for example, a size of a customer, an annual revenue of a customer, products produced or sold by the customer, services provided by the customer to other customers, and employee information associated with the customer.

The system generates a training set including the historical customer data (Operation 406). The training data set includes, for multiple customers and products, (a) customer experience content attribute data associated with a set of customer experience content, (b) target customer attribute data, and (c) a target customer effectiveness score, indicating an effectiveness of providing the customer experience content to the target customer in a marketing opportunity.

The system applies a machine learning algorithm to the training data set (Operation 408). The machine learning algorithm analyzes the training data set to identify data and patterns that indicate relationships between customer experience content attributes, target customer attributes, and target customer effectiveness scores associated with the corresponding customer experience content and target customer attributes.

In examples of supervising ML algorithms, the system may obtain feedback on the whether a particular target customer effectiveness score should be applied to a particular pair of (a) customer experience content and (b) a particular target customer (Operation 410). The feedback may affirm that a particular target customer effectiveness score is appropriate for a particular pair of (a) customer experience content and (b) a particular target customer. In other examples, the feedback may indicate that a particular target customer effectiveness score should not be associated with a particular pair of (a) customer experience content and (b) a particular target customer. Based on the feedback, the machine learning training set may be updated, thereby improving its analytical accuracy (Operation 412). Once updated, the system may further train the machine learning model by optionally applying the model to additional training data sets.

### 6. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

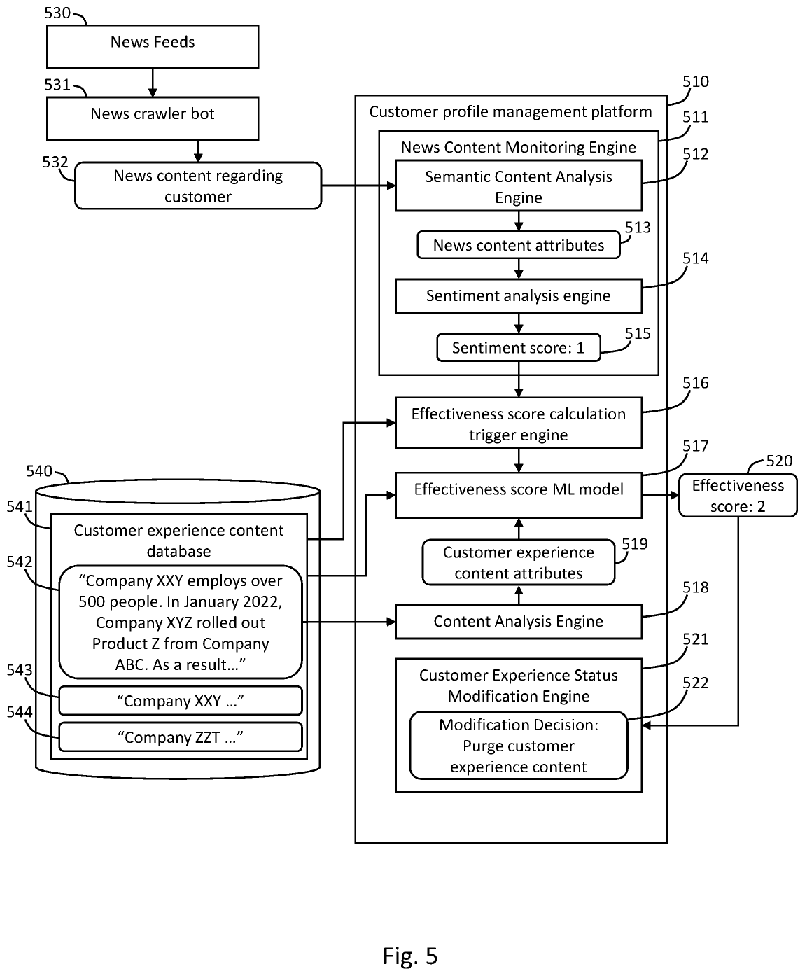

FIG. 5 illustrates an example of a customer profile management platform 510 managing customer experience content. A news crawler bot 531 continuously scans news feeds 530 to identify news content 532 associated with an existing customer. The news content monitoring engine 511 detects the news content 532. The news content monitoring engine 511 applies a semantic content analysis engine 512 to the news content 532 to identify news content attributes, including customer identification information and news event information (such as “sales increased . . . ”, “Company X laid off 50 employees . . . ”, “ . . . an investigation has been opened into Company X . . . ”, “Company X is expanding into Brasil . . . ”, etc.) A sentiment analysis engine 514 analyzes the news content attribute data to generate a sentiment score 515 associated with the news content. In the example illustrated in FIG. 5, the sentiment analysis engine 514 generates a low sentiment score (“1”) based on determining the sentiment of the news content is very negative (e.g., “ . . . the S.E.C. has opened an investigation into the practices of Company XXY . . . ”)

An effectiveness score calculation trigger engine 516 analyzes at least the sentiment score 515 generated by the news content monitoring engine 511 to determine whether to initiate a re-calculation of an effectiveness score associated with a particular set of customer experience content. When determining whether to initiate the re-calculation of the effectiveness score, the effectiveness score calculation trigger engine 516 may also consider data stored in the customer experience content database 541. For example, the effectiveness score calculation trigger engine 516 may apply a set of rules specifying: “if (a) at least three events (e.g., new news content, new service requests, modifications to customer experience content) have occurred within the last four months, and (b) if the sum of the sentiment scores associated with the at least three events does not exceed ‘12’ (out of a potential of ‘30’ for the three events), trigger a re-calculation of the effectiveness score for any related customer experience content.”

In the example embodiment illustrated in FIG. 5, the effectiveness score calculation trigger engine applies a set of rules to at least the sentiment score 515, and optionally to data from the customer experience content database 541 and triggers a recalculation of an effectiveness score.

A data repository 540 hosts the customer experience content database 541. The customer experience content database 541 includes multiple different sets of customer experience content associated with multiple different customers and multiple different products. In the example embodiment illustrated in FIG. 5, the sets 542, 543, and 544 of customer experience content are narrative-type customer experience content, such as testimonials or case studies. Sets 542 and 543 describe two different experiences of customer “Company XXY” with two different products. Set 544 describes an experience of a different company, “Company ZZT”, with a product.

Since the news content associated with the sentiment score 515 is associated with the customer “Company XXY,” the effectiveness score machine learning model 517 may re-calculate effectiveness scores for each set 542 and 543 of customer experience content associated with Company XXY.

A content analysis engine 518 generates customer experience content attributes 519 from a set of customer experience content 542. The content analysis engine 518 may include: a semantic content analysis engine (similar to the engine 512) to identify semantic content. The content analysis engine 518 may include a sentiment analysis engine (similar to engine 514) to identify a sentiment associated with a set of customer experience content 542. The effectiveness score machine learning model 517 receives as input data: (a) the customer experience content attributes 519 and (b) the sentiment score 515. The effectiveness score machine learning model 517 may further receive as input data additional attribute data associated with the customer experience content 542. The additional attribute data may be stored as metadata in the customer experience content database 541. Examples of additional data include: information about the customer, including customer size, customer revenue, information about a number and type of customers serviced by the particular customer, industry type, information about previous service requests, information about previous news content, growth information about the customer, and employee information. The effectiveness score machine learning model 517 converts the input data into a format digestible by the machine learning model. For example, the model 517 may convert text data into numerical and/or vector data. The model 517 may normalize numerical data. For example, the model 517 may convert numerical values that range between 0 and 99,999 into vector values between −1 and 1.

The effectiveness score machine learning model 517 generates an effectiveness score 520 for the customer experience content 542. The effectiveness score machine learning model 517 may also generate effectiveness scores for any other customer experience content associated with the trigger, such as customer experience content 543.

A customer experience content status modification engine 521 analyzes the effectiveness score 520 for the customer experience content 542 to identify a remediating action to perform in connection with the customer experience content 542. The customer experience content status modification engine 521 compares the effectiveness score 520 to one or more thresholds to determine an action to perform. In the embodiment illustrated in FIG. 5, the customer experience content status modification engine 521 compares the effectiveness score 520 to a threshold value of “4.” The customer experience content status modification engine 521 applies a rule indicating that “if an effectiveness score is less than 4, purge the corresponding customer experience content from the customer experience content database.” Since the customer experience content status modification engine 521 determines that the particular effectiveness score (“2”) associated with the set of customer experience content 542 is less than 4, the customer experience content status modification engine 521 purges the set of customer experience content 542 from the customer experience content database 541.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

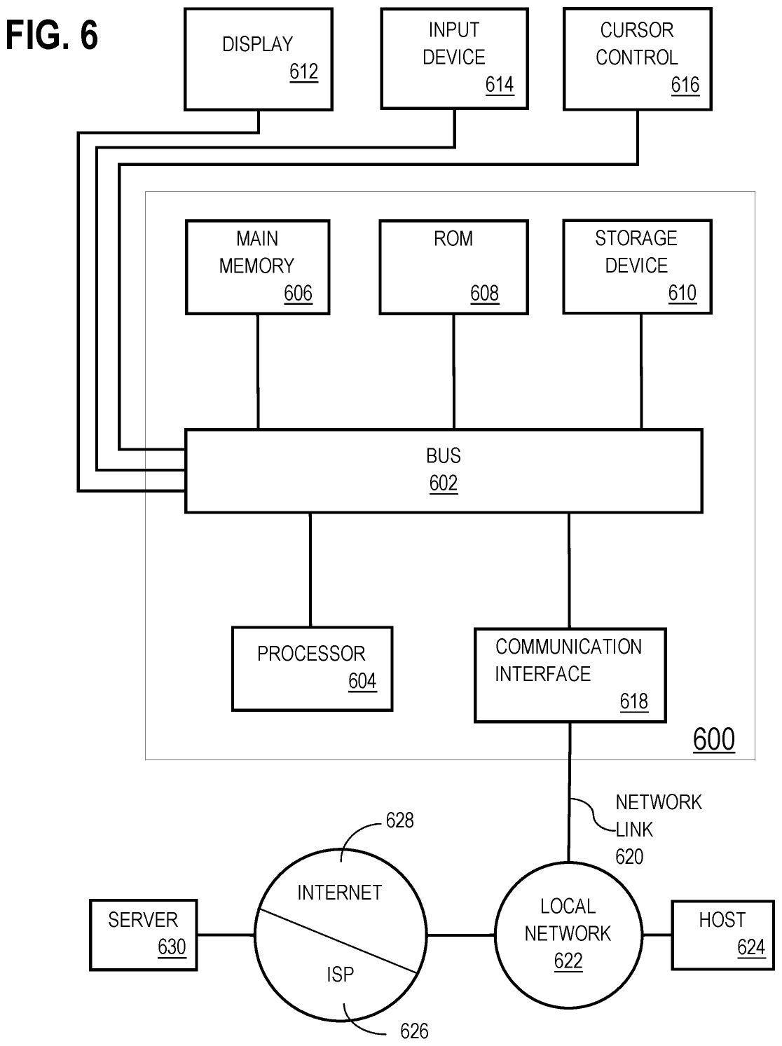

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
training a machine learning model to compute effectiveness scores for customer experience content, the training comprising:
obtaining training data sets of historical data, each training data set of historical data comprising:
attributes corresponding to a set of historical customer experience content associated with a customer experience with a first set of goods and/or services; and
an effectiveness score associated with the historical customer experience content, wherein the effectiveness score corresponds to an effectiveness of using the historical customer experience content for marketing a second set of goods and/or services; and
training the machine learning model based on the training data sets;
receiving attributes of a first set of customer experience content; and
applying the machine learning model to the attributes of the first set of customer experience content to compute a first effectiveness score for the first set of customer experience content.

2. The non-transitory computer readable medium of claim 1, wherein the operations further comprise:
detecting a modification to the attributes of the first set of customer experience content,
wherein the machine learning model is applied to the attributes of the first set of customer experience content responsive to detecting the modification.

3. The non-transitory computer readable medium of claim 1, wherein the operations further comprise:
comparing the first effectiveness score to a first threshold value and a second threshold value, the second threshold value being higher than the first threshold value; and
based on determining the first effectiveness score (a) equals or exceeds the first threshold value, and (b) is lower than the second threshold value:
classifying the first set of customer experience content for non-use for a predetermined period of time to prevent use of the first set of customer experience content for marketing to a target customer.

4. The non-transitory computer readable medium of claim 1, wherein the operations further comprise:
comparing the first effectiveness score to a first threshold value; and
based on determining the first effectiveness score is less than the threshold value, purging the first set of customer experience content from a repository of sets of customer experience content.

5. The non-transitory computer readable medium of claim 4, wherein the operations further comprise:
comparing a second effectiveness score, associated with a second set of customer experience content, to the first threshold value and a second threshold value, the second threshold value being higher than the first threshold value;
based on determining the second effectiveness score is equal to, or higher than, the second threshold value, keeping a second set of customer experience content in the repository of sets of customer experience content;
comparing a third effectiveness score, associated with a third set of customer experience content, to the first threshold value and the second threshold value; and
based on determining the third effectiveness score: (a) equals or exceeds the first threshold value, and (b) is lower than the second threshold value:
flagging the third set of customer experience content for human review.

6. The non-transitory computer readable medium of claim 4, wherein the repository of sets of customer experience content is a repository from which a marketing entity obtains sets of customer experience content to provide to potential customers,
wherein the operations further comprise:
identifying attributes of a target customer;
analyzing a plurality of sets of customer experience content in the repository to identify one or more sets of customer experience content matching attributes of the target customer; and
providing the one or more sets of customer experience content to the target customer;
wherein attributes of the one or more sets of customer experience content match the attributes of the target customer, and
wherein the operations further comprise:
based on the purging of the first set of customer experience content from the repository, omitting the first set of customer experience content from the analysis of the plurality of sets of customer experience content.

7. The non-transitory computer readable medium of claim 1, wherein each training data set of historical data further comprises attributes of a particular customer for which the effectiveness score associated with the historical customer experience content was computed,
wherein the first effectiveness score for the first set of customer experience content is to be used for determining whether to use the first set of customer experience content to market a third set of goods and/or services to a target customer, and
wherein applying the machine learning model comprises:
applying the machine learning model to attributes of the target customer.

8. The non-transitory computer readable medium of claim 1, wherein the operations further comprise:
identifying one or more news accounts associated with the first set of customer experience content,
wherein applying the machine learning model to the first set of customer experience content includes applying the machine learning model to customer experience content attribute data associated with the first set of customer experience content and news account attribute data associated with the one or more news accounts.

9. The non-transitory computer readable medium of claim 8, wherein identifying the one or more news accounts, comprises:
monitoring one or more news feeds to identify a news account associated with the first set of customer experience content;
analyzing, by a content analysis engine, content of the news account to determine a sentiment associated with the news account;
generating a sentiment score associated with the news account based on a particular sentiment identified in the news account; and
including the sentiment score among the news account attribute data to which the machine learning model is applied.

10. The non-transitory computer readable medium of claim 9, wherein the operations further comprise:
initiating the applying the machine learning model to the first set of customer experience content and the news account attribute data based on generating the sentiment score.

11. The non-transitory computer readable medium of claim 1, wherein the operations further comprise:
obtaining service request data associated with a service request from a customer associated with the first set of customer experience content,
wherein applying the machine learning model to the first set of customer experience content includes applying the machine learning model to customer experience content attribute data associated with the first set of customer experience content and service request attribute data associated with the service request data.

12. The non-transitory computer readable medium of claim 11, wherein the operations further comprise:
monitoring a service request platform to identify service requests associated with the customer;
extracting the service request attribute data from the service requests, the service request attribute data comprising one or more of:
a number of service requests associated with the customer;
a number of service requests associated with the first set of customer experience content;
types of service requests; and
customer sentiment information included in service requests.

13. The non-transitory computer readable medium of claim 12, wherein the operations further comprise:
detecting a new service request associated with the first set of customer experience content,
wherein obtaining the service request data and applying the machine learning model to the first set of customer experience content and the service request attribute data is performed based on detecting the new service request.

14. The non-transitory computer readable medium of claim 1, wherein the attributes corresponding to the set of historical customer experience content comprise:
a customer identity;
a product and/or service associated with the customer; and
data associated with a description of a customer experience with the product and/or service at a particular period of time, and
wherein the attributes corresponding to the set of historical customer experience content further comprise at least one of:
news account data corresponding to a news account associated with the customer and the particular period of time; and
service request data corresponding to one or more of a number, type, and resolution state of service requests by the customer to a service provider associated with the product and/or service.

15. The non-transitory computer readable medium of claim 1, wherein the attributes corresponding to the set of historical customer experience content comprise:
a customer identity;
a product and/or service associated with the customer; and
data associated with a description of a customer experience with the product and/or service at a particular period of time, and
wherein the attributes corresponding to the set of historical customer experience content further comprise at least one of:
news account data corresponding to a first news account associated with the customer and the particular period of time; and
service request data corresponding to one or more of a number, type, and resolution state of service requests by the customer to a service provider associated with the product and/or service,
wherein the operations further comprise:
detecting a modification to the attributes of the first set of customer experience content,
wherein the machine learning model is applied to the attributes of the first set of customer experience content responsive to detecting the modification,
wherein the operations further comprise:
comparing the first effectiveness score to a first threshold value and a second threshold value, the second threshold value being higher than the first threshold value;
based on determining the first effectiveness score (a) equals or exceeds the first threshold value, and (b) is lower than the second threshold value:
classifying the first set of customer experience content for non-use for a predetermined period of time to prevent use of the first set of customer experience content for marketing to a target customer,
wherein the operations further comprise:
applying the machine learning model to attributes of a second set of customer experience content to compute a second effectiveness score for the second set of customer experience content;
comparing the second effectiveness score to the first threshold value;
based on determining the second effectiveness score is less than the first threshold value, purging the second set of customer experience content from a repository of sets of customer experience content,
wherein the operations further comprise:
comparing a third effectiveness score, associated with a third set of customer experience content, to the first threshold value and a third threshold value, the third threshold value being higher than the first threshold value;
based on determining the third effectiveness score is equal to, or higher than, the third threshold value, keeping the third set of customer experience content in the repository of sets of customer experience content;
comparing a fourth effectiveness score, associated with a fourth set of customer experience content, to the first threshold value and the third threshold value;
based on determining the fourth effectiveness score: (a) equals or exceeds the first threshold value, and (b) is lower than the second threshold value:
flagging the fourth set of customer experience content for human review;
wherein the repository of sets of customer experience content is a repository from which a marketing entity obtains sets of customer experience content to provide to potential customers,
wherein the operations further comprise:
identifying attributes of a target customer;
analyzing a plurality of sets of customer experience content in the repository to identify one or more sets of customer experience content matching attributes of the target customer;
providing the one or more sets of customer experience content to the target customer;
wherein attributes of the one or more sets of customer experience content match the attributes of the target customer, and
wherein the operations further comprise:
based on the purging of the second set of customer experience content from the repository, omitting the second set of customer experience content from the analysis of the plurality of sets of customer experience content,
wherein the operations further comprise:
identifying one or more news accounts associated with the first set of customer experience content,
wherein applying the machine learning model to the first set of customer experience content includes applying the machine learning model to customer experience content attribute data associated with the first set of customer experience content and news account attribute data associated with the one or more news accounts,
wherein identifying the one or more news accounts, comprises:
monitoring one or more news feeds to identify the first news account associated with the first set of customer experience content;
analyzing, by a content analysis engine, content of the first news account to determine a sentiment associated with the first news account;
generating a sentiment score associated with the first news account based on a particular sentiment identified in the first news account; and
including the sentiment score among the news account attribute data to which the machine learning model is applied,
wherein the operations further comprise:
initiating the applying the machine learning model to the first set of customer experience content and the news account attribute data based on generating the sentiment score,
wherein the operations further comprise:
obtaining the service request data associated with a first service request from a customer associated with the first set of customer experience content,
wherein applying the machine learning model to the first set of customer experience content includes applying the machine learning model to customer experience content attribute data associated with the first set of customer experience content and service request attribute data associated with the service request data,
wherein the operations further comprise:
monitoring a service request platform to identify service requests associated with the customer;
extracting the service request attribute data from the service requests, the service request attribute data comprising one or more of:
a number of service requests associated with the customer;
a number of service requests associated with the first set of customer experience content;
types of service requests; and
customer sentiment information included in service requests,
wherein the operations further comprise:
detecting a new service request associated with the first set of customer experience content,
wherein obtaining the service request data and applying the machine learning model to the first set of customer experience content and the service request attribute data is performed based on detecting the new service request.

16. A method comprising:
training a machine learning model to compute effectiveness scores for customer experience content, the training comprising:
obtaining training data sets of historical data, each training data set of historical data comprising:
attributes corresponding to a set of historical customer experience content associated with a customer experience with a first set of goods and/or services; and
an effectiveness score associated with the historical customer experience content, wherein the effectiveness score corresponds to an effectiveness of using the historical customer experience content for marketing a second set of goods and/or services; and
training the machine learning model based on the training data sets;
receiving attributes of a first set of customer experience content; and
applying the machine learning model to the attributes of the first set of customer experience content to compute a first effectiveness score for the first set of customer experience content.

17. The method of claim 16, further comprising:
detecting a modification to the attributes of the first set of customer experience content,
wherein the machine learning model is applied to the attributes of the first set of customer experience content responsive to detecting the modification.

18. The method of claim 16, further comprising:
comparing the first effectiveness score to a first threshold value and a second threshold value, the second threshold value being higher than the first threshold value; and
based on determining the first effectiveness score (a) equals or exceeds the first threshold value, and (b) is lower than the second threshold value:
classifying the first set of customer experience content for non-use for a predetermined period of time to prevent use of the first set of customer experience content for marketing to a target customer.

19. The method of claim 16, further comprising:
comparing the first effectiveness score to a first threshold value; and
based on determining the first effectiveness score is less than the threshold value, purging the first set of customer experience content from a repository of sets of customer experience content.

20. The method of claim 19, further comprising:
comparing a second effectiveness score, associated with a second set of customer experience content, to the first threshold value and a second threshold value, the second threshold value being higher than the first threshold value;
based on determining the second effectiveness score is equal to, or higher than, the second threshold value, keeping a second set of customer experience content in the repository of sets of customer experience content;
comparing a third effectiveness score, associated with a third set of customer experience content, to the first threshold value and the second threshold value; and
based on determining the third effectiveness score: (a) equals or exceeds the first threshold value, and (b) is lower than the second threshold value:
flagging the third set of customer experience content for human review.

21. A system comprising:
one or more processors; and
memory storing instructions that, when executed by the one or more processors, cause the system to perform operations comprising:
training a machine learning model to compute effectiveness scores for customer experience content, the training comprising:
obtaining training data sets of historical data, each training data set of historical data comprising:
attributes corresponding to a set of historical customer experience content associated with a customer experience with a first set of goods and/or services; and
an effectiveness score associated with the historical customer experience content, wherein the effectiveness score corresponds to an effectiveness of using the historical customer experience content for marketing a second set of goods and/or services; and
training the machine learning model based on the training data sets;
receiving attributes of a first set of customer experience content; and
applying the machine learning model to the attributes of the first set of customer experience content to compute a first effectiveness score for the first set of customer experience content.
